(19) United States
(12) Patent Application Publication
(10) Pub. No.: US 2017/0135039 A1
(43) Pub. Date: May 11, 2017

(54) USER TERMINAL, BASE STATION AND COMMUNICATION METHOD

(71) Applicant: NTT DOCOMO, INC., Tokyo (JP)

(72) Inventors: Kazuaki Takeda, Tokyo (JP); Hiroki Harada, Tokyo (JP); Hiroyuki Ishii, Palo Alto, CA (US)

(73) Assignee: NTT DOCOMO, INC., Tokyo (JP)

(21) Appl. No.: 15/127,520

(22) PCT Filed: Mar. 13, 2015
(86) PCT No.: PCT/JP2015/057496

§ 371 Date: Sep. 20, 2016

(30) Foreign Application Priority Data
Mar. 20, 2014 (JP) 2014-058836

(51) Int. Cl. H04W 52/02; H04L 5/00; H04W 72/04

(52) U.S. Cl. CPC H04W 52/0225; H04W 72/042; H04W 72/0446; H04L 5/0048

(57) ABSTRACT

The present invention is designed to reduce the delay time which a small cell takes before starting transmitting data to a user terminal. A user terminal according to the present invention has a measurement section that, when the state of connection with the small base station is a deactivated state, periodically measures channel state information, by using a channel state information reference signal that is transmitted from the small base station, and a monitoring section that, when the state of connection is the deactivated state, periodically monitors a downlink control channel that is transmitted from the small base station, wherein, when downlink control information for the user terminal is detected by the periodic monitoring of the downlink control channel, the state of connection is switched from the deactivated state to an activated state.

### TECHNICAL FIELD

The present invention relates to a user terminal, a base station, a communication system and a communication method in a next-generation communication system in which a user terminal communicate with a first base station and a second base station at the same time.

### BACKGROUND ART

In LTE (Long Term Evolution) and successor systems of LTE (referred to as, for example, “LTE-advanced,” “FRA (Future Radio Access),” “4G,” etc.), a radio communication system (referred to as, for example, a “HetNet” (Heterogeneous Network)), in which cells each having a relatively small coverage of a radius of approximately several meters to several tens of meters (hereinafter referred to as “small cells,” and also referred to as “pico cells,” “femto cells” and so on) are placed to overlap a cell having a relatively large coverage of a radius of approximately several hundred meters to several kilometers (hereinafter referred to as a “macro cell”), is under study (see, for example, non-patent literature 1).

With this radio communication system, not only the scenario to use carriers (component carriers (CCs)) of the same frequency band between the macro cell and the small cells, but also the scenario to use carriers of different frequency bands is under study.

### CITATION LIST

### Non-Patent Literature

Non-Patent Literature 1: 3GPP TR 36.814 “E-UTRA Further Advancements for E-UTRA Physical Layer Aspects”

### SUMMARY OF INVENTION

### Technical Problem

In the above-noted radio communication system, the small cells may be placed densely in specific locations in the macro cell where the traffic is relatively heavy (for example, train stations). In this case, in order to reduce the interference between neighboring small cells, a study is in progress to use on/off control to switch between the on state and the off state of small cells (also referred to as “small base stations,” “secondary (S) cells,” etc.).

To be more specific, on/off control to allow a small cell to switch from the off state to the on state based on whether or not there is traffic for a user terminal is under study. In order to achieve improved throughput in a small cell while on/off control is used, it is preferable to reduce the delay time which the small cell takes after being switched from the off state to the on state until starting transmitting data to a user terminal.

The present invention has been made in view of the above, and it is therefore an object of the present invention to provide a user terminal, a base station, a communication system and a communication method that can reduce the delay time which a small cell takes before starting transmitting data to a user terminal.

### Solution to Problem

The user terminal of the present invention provides a user terminal that communicates with a first base station and a second base station at the same time, and this user terminal has a measurement section that, when a state of connection between the first base station and the user terminal is a deactivated state, periodically measures channel state information, by using a channel state information reference signal that is transmitted from the first base station, and a monitoring section that, when the state of connection is the deactivated state, periodically monitors a downlink control channel that is transmitted from the first base station, and, when downlink control information for the user terminal is detected by the periodic monitoring of the downlink control channel, the state of connection is switched from the deactivated state to an activated state.

### Advantageous Effects of Invention

According to the present invention, it is possible to reduce the delay time which a small cell takes before starting transmitting data to a user terminal.

### BRIEF DESCRIPTION OF DRAWINGS

FIG. 1 is a diagram to explain a HetNet structure;

FIG. 2 is a diagram to explain an example scenario to place small cells densely

FIG. 3 is a diagram to explain interference between neighboring small cells;

FIG. 4 is a diagram to explain on/off control of small cells;

FIG. 5 is a sequence diagram to show off/off state switching operations for small cells;

FIG. 6 is a diagram to explain the delay time that begins when a small cell is switched from the off state to the on state, and lasts until data starts being transmitted to a user terminal;

FIG. 7 is a diagram to explain the radio communication method of the present invention;

FIG. 8 is a diagram to show downlink transmission signals of small cells according to the radio communication method of the present invention;

FIG. 9 is a sequence diagram to show the radio communication method of the present invention;

FIG. 10 is a flowchart to show the operation of user terminals in the radio communication method of the present invention;

FIG. 11 is a diagram to show an overall structure of a radio communication system according to the present embodiment;

FIG. 12 is a diagram to show a schematic structure of a radio base station according to the present embodiment;

FIG. 13 is a diagram to show a schematic structure of a user terminal according to the present embodiment;

FIG. 14 is a diagram to show a detailed structure of a small base station according to the present embodiment; and

FIG. 15 is a diagram to show a detailed structure of a user terminal according to the present embodiment.

### DESCRIPTION OF EMBODIMENTS

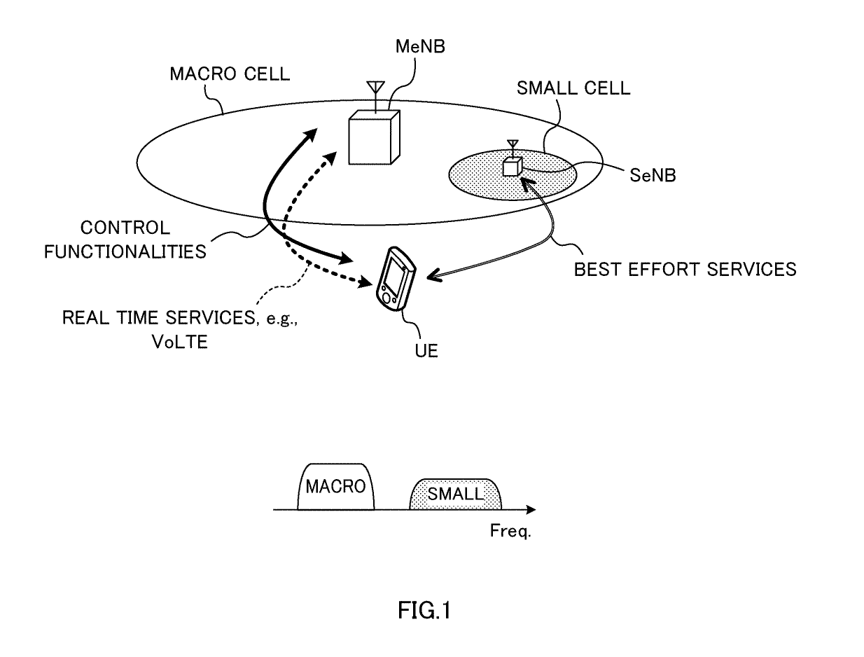

FIG. 1 is a conceptual diagram of a HetNet. As shown in FIG. 1, a HetNet refers to a radio communication system in which a macro cell and a small cell are placed to geographically overlap each other at least in part. The HetNet is comprised of a radio base station that forms a macro cell (hereinafter referred to as a “macro base station” (MeNB: Macro eNodeB)), a radio base station that forms a small cell (hereinafter referred to as a “small base station” (SeNB: Small eNodeB), and a user terminal (UE: User Equipment) that communicates with the macro base station and the small base station.

Referring to FIG. 1, a relatively low frequency band (for example, 800 MHz, 2 GHz and so on) is used in the macro cell, and a relatively high frequency band (for example, 3.5 GHz and so on) is used in the small cell. Also, not only licensed bands such as, for example, 3.5 GHz, but also unlicensed bands, such as, for example, 5 GHz, may be used in the small cell. Also, lower transmission power is used in the small cell than in the macro cell.

Also, in relationship to the HetNet, a study is also in progress to achieve increased capacity in small cells and improved throughput in user terminals, while securing coverage and mobility with macro cells (also referred to as “macro-assisted small cell operation,” “C/U-plane split,” etc.). To be more specific, there is a plan to carry out control (C)-plane communication to involve control signals and so on in macro cells, and carry out user (U)-plane communication to involve user data and so on in small cells. Note that, as shown in FIG. 1, part of the user (U)-plane communication such as real-time-based services may be carried out in macro cells.

Also, with the HetNet, a study is also in progress to place small cells in varying densities and in different environments (for example, indoors, outdoors and so on). Generally speaking, the distribution of users and traffic are not even, but change over time or between locations. For example, it may be possible to raise the density of placing small cells (dense small cells) in train stations, shopping malls and so on where many user terminals gather, and lower the density of placing small cells (sparse small cells) in places where user terminals do not gather.

Note that the above small cells are used by a user terminal by way of carrier aggregation with a macro cell (primary (P) cell). Here, carrier aggregation (CA) refers to aggregating carriers (component carriers) between a macro cell (Pcell) and at least one small cell (Scell). In carrier aggregation, a user terminal communicates with the radio base station to form the macro cell (hereinafter referred to as the “macro base station”) and the radio base station to form the small cell (hereinafter referred to as the “small base station”) at the same time.

Also, carrier aggregation includes “inter-base station carrier aggregation” (intra-eNB CA) (also referred to simply as “carrier aggregation”) and inter-base station carrier aggregation (inter-eNB CA) (also referred to as “dual connectivity”). In intra-base station CA, a macro base station may schedule small base stations. Also, in inter-base station CA (dual connectivity), a user terminal may connect with both a macro cell and a small cell, and the macro base station and the small base station may carry out the scheduling. Cases of inter-base station CA (dual connectivity) will be primarily described below.

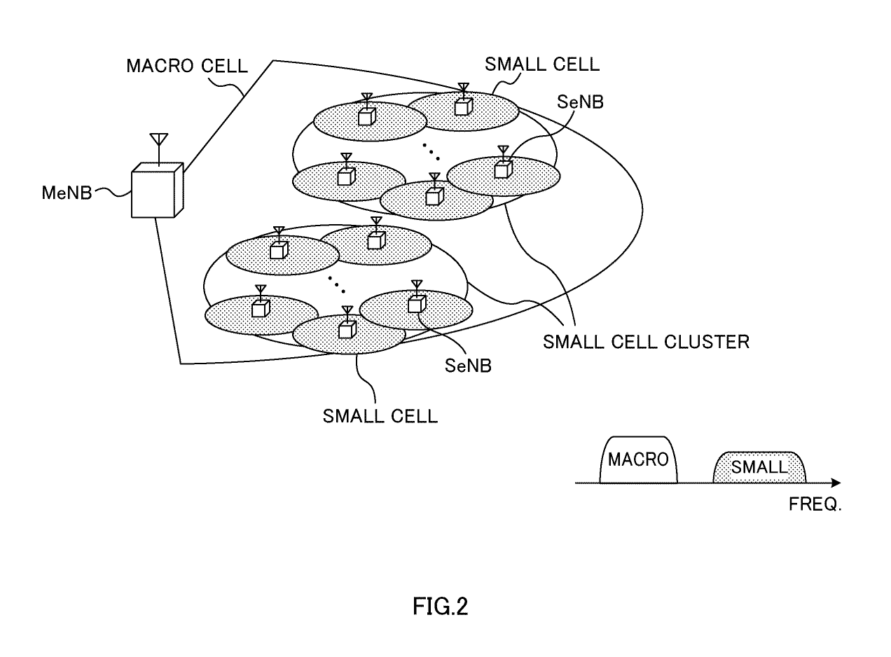

FIG. 2 is a diagram to explain an example scenario to place small cells densely. As shown in FIG. 2, a scenario to place small cells densely within a cluster of a specific range (small cell cluster) may be possible (for example, the Rel-12 SCE (Small Cell Enhancement) scenario, which hereinafter will be referred to as the “SCE scenario”) is assumed. With this SCE scenario, there is a threat that interference from neighboring small cells causes a deterioration of received quality in user terminals (for example, the RSRQ (Reference Signal Received Quality), the SINR (Signal Interference and Noise Ratio), etc.).

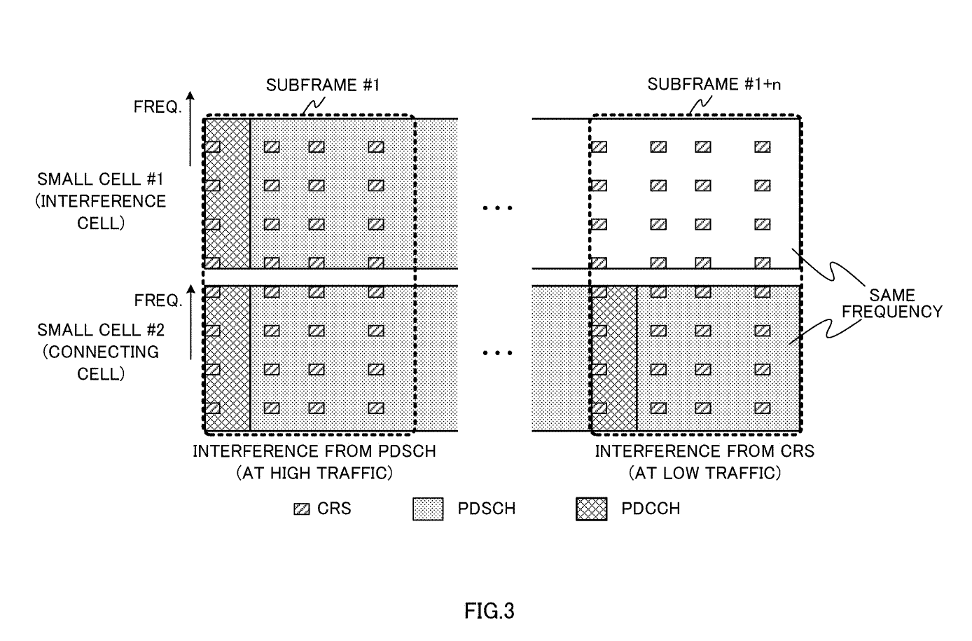

FIG. 3 is a diagram to explain interference between neighboring small cells #1 and #2 in the SCE scenario. Assume that, in FIG. 3, a user terminal connects with small cell (small base station) #2. Also, the signal structure shown in FIG. 3 is simply an example, and this is by no means limiting. Although unillustrated in FIG. 3, synchronization signals (for example, PSS (Primary Synchronization Signal), SSS (Secondary Synchronization Signal), reference signals and so on may be placed. Also, assume that, in FIG. 3, the same frequency is used in small cells #1 and #2.

As shown with subframe #1 of FIG. 3, when traffic is relatively heavy, a downlink shared channel (PDSCH: Physical Downlink Shared CHannel) is allocated in both small cell #1 and #2. In this case, the PDSCH of small cell #2 where the user terminal is connected suffers interference from the PDSCH of small cell #1.

Meanwhile, as shown with subframe #1+n (n≧1) in FIG. 3, when the traffic is relatively light, the PDSCH of small cell #2 suffers interference from the cell-specific reference signal (CRS) and the synchronization signals (not shown) of small cell #1.

In this way, with the SCE scenario, there is a threat that interference from neighboring small cells causes a deterioration of received quality in user terminals. As a result of this, the effect of improving throughput by heightening the density of small cells may see its limit. Also, according to the SCE scenario, small cells are placed without taking into consideration the relationship between the cells in terms of their locations in order to make cell planning easy, interference from neighboring small cells is likely to increase.

Consequently, in the SCE scenario, it is preferable to apply interference coordination (ICIC: Inter-Cell Interference Coordination) between small cells. For interference coordination between small cells, for example, it may be possible to use on/off control to switch between the on state and the off state of small cells (also referred to as “small base stations,” “secondary (S) cells,” etc.).

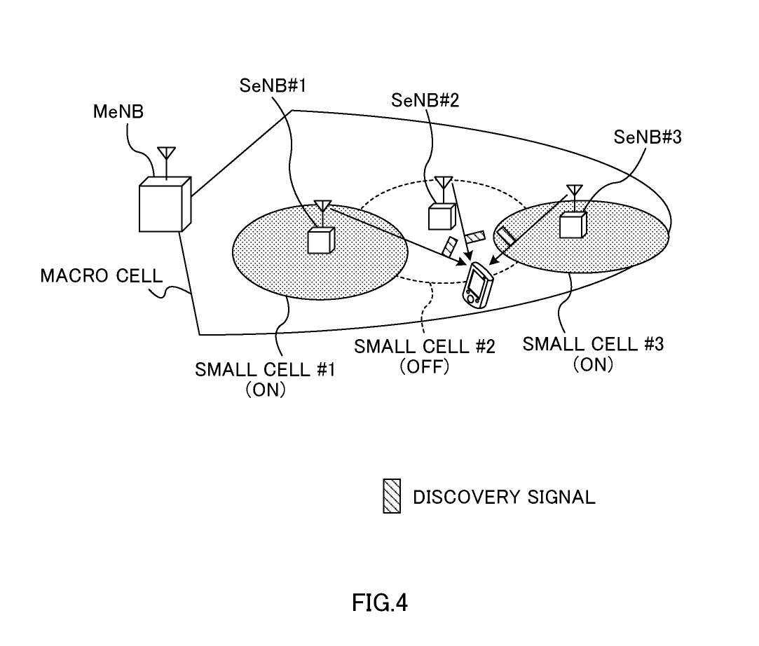

FIG. 4 is a diagram to explain the on/off control in the SCE scenario. Assume that, in FIG. 4, for example, small cells 1 and 3 are in the on state, and a small cell 2 is in the off state. Also, the on state refers to the state in which the small cells transmit PDSCHs and CRSs, and the off state refers to the state in which the small cells stop transmitting PDSCHs and CRSs.

As shown in FIG. 4, small base stations 1 to 3 each transmit discovery signals in bursts. Here, the discovery signals are signals that are used to detect/measure the small cells (detection/measurement signals) (also referred to simply as “detection signals”). The discovery signals are transmitted in bursts, in a relatively cycle of, for example, 100 ms, 160 ms and so on. Here, “in bursts” means that the discovery signals are transmitted in, for example, 1 ms or 2 ms. Also, the small base stations 1 to 3 transmit discovery signals synchronously. By transmitting discovery signals synchronously, it is possible to reduce the discovery signal measurement period in the user terminal, so that a battery saving effect can be achieved. Note that information regarding the burst transmissions of discovery signals (for example, subframe numbers, sequences, transmission cycles and so on) may be reported from macro base station to the user terminal.

In the on/off control shown in FIG. 4, the user terminal measures the received power and/or the received quality (hereinafter referred to as “received power/received quality”) in the small cells 1 to 3 by using the discovery signals from the small base stations 1 to 3. Based on the measurement results, the macro base station configures the small cells 1 to 3 as small cells (secondary (S) cells) to perform carrier aggregation with the macro cell (primary (P) cell), and executes on/off control of the small cells 1 to 3 based on the traffic for the user terminal. Note that, the RSRP (Reference Signal Received Power) may be used for the received power, and the RSRQ, the SINR and so on may be used for the received quality.

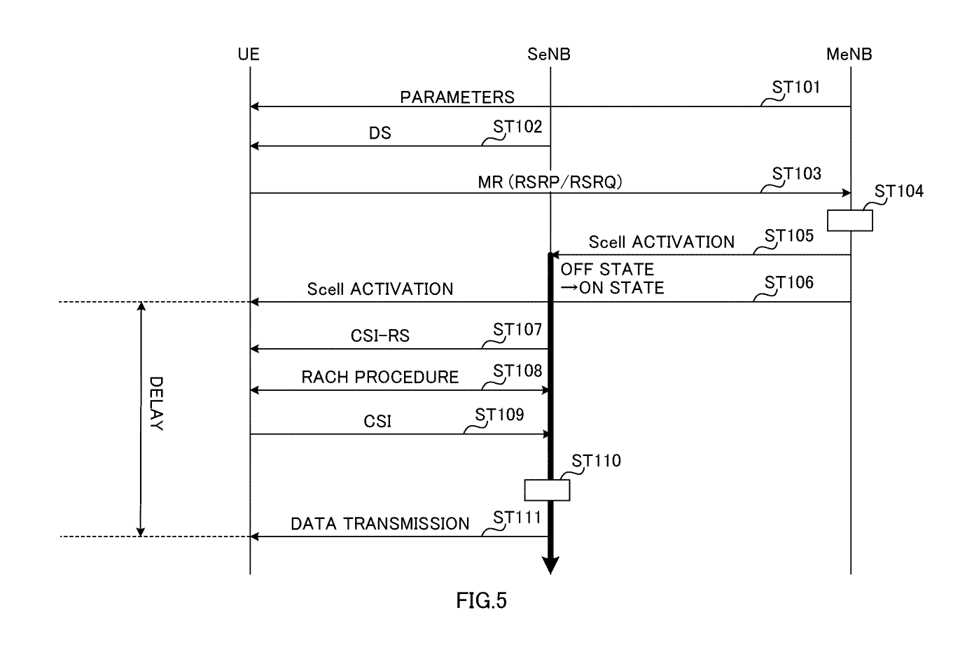

FIG. 5 is a diagram to explain the on/off state switching procedures for small cells. The procedures for switching small cells from the off state to the on state will be described with reference to FIG. 5. Note that, with FIG. 5, an example case will be described in which inter-base station carrier aggregation (dual connectivity) is used between the macro cell and the small cells. Note that, in the event of inter-base station carrier aggregation, the macro cell and the small cells are both controlled by one base station, so that the base station to control the macro cell may be understood to schedule the small cells.

As shown in FIG. 5, the macro base station reports parameter information of the signals transmitted from the small base stations, to a user terminal (step ST101). This parameter information may include information about the above-described burst transmission of discovery signals (for example, subframe numbers, sequences, transmission cycles and so on), information about the structure of channel state information reference signals (CSI-RSs), and so on.

The small base stations transmit discovery signals to the user terminal (step ST102). The user terminal sends a measurement report (MR), which represents the measurement results of the received power/received quality of the discovery signals, to the macro base station (step ST103).

The macro base station, based on the measurement report from the user terminal, determines which small cell is going to execute carrier aggregation with the macro cell (step ST104). For example, the macro base station may determines a small cell where the received quality of the discovery signal in the user terminal is equal to or higher (or greater) than a predetermined threshold to be a small cell to be involved in carrier aggregation.

Here, if the small cell is in the off state, the user terminal is in the state of deactivation, in which the user terminal does not monitor a downlink control channel (PDCCH: Physical Downlink Control CHannel) (“PDCCH monitoring”) or report CSI (“CSI reporting,” “CQI/PMI/RI/PTI reporting,” etc.). Also, upon receiving a command from the macro base station, the user terminal transitions to the state of activation, in which the user terminal monitors a downlink control channel, measures and reports CSI, and so on.

The user terminal is commanded to activate the small cell (step ST106), and, at the same time, starts measuring channel state information (CSI) by using the CSI-RS from the small base station. Note that the command information for the user terminal may be reported in, for example, MAC (Medium Access Control) signaling. Also, if, at the same time as the activation by the user terminal, the small cell transitions from the off state to the on state and starts transmitting downlink signals such as the CSI-RS (step ST107), the user terminal can start measuring CSI without delay.

Note that the CSI is information that is used to schedule the PDSCH from the small base station, and may include at least one of a channel quality indicator (CQI), a rank indicator (RI) and a precoding matrix indicator (PMI).

When the user terminal needs to establish uplink synchronization, carries out the random access procedures with the small base station (step ST108), and reports CSI to the small base station (step ST109). Note that the random access procedures may be skipped, or the random access procedures and the reporting of CSI may be carried out together.

The small base station, based on the CSI from the user terminal, schedules the PDSCH to transmit from the small base station (step ST110).

With the above-described switching procedures, there is a threat that the delay time which a small cell takes after being switched from the off state to the on state until starting transmitting data to a user terminal causes a decrease of throughput.

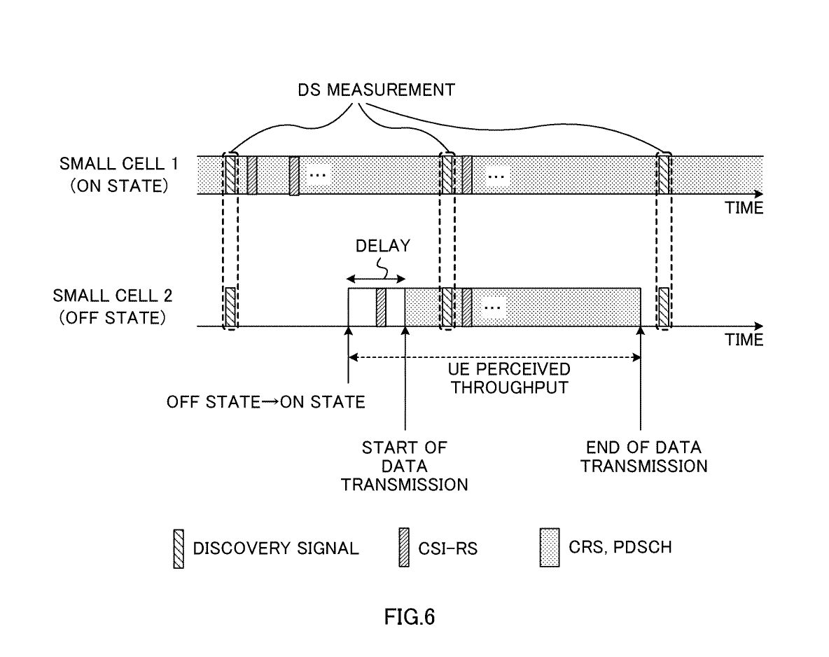

The delay time that is produced when a small cell is switched from the off state to the on state will be described in detail with reference to FIG. 6. Assume that, in FIG. 6, the small cell 1 is in the on state, and the small cell 2 is switched from the off state to the on state. Note that FIG. 6 is simply an example, and this is by no means limiting.

As shown in FIG. 6, in the small cell 1 in the on state, the discovery signal is transmitted in a predetermined cycle (for example, 100 ms, 160 ms, etc.), and the CRS and the PDSCH are transmitted in every subframe. Note that, for example, in a new carrier type, which refers to a carrier of a new type, the CRS needs not be transmitted. In the small cell 1 in the on state, a user terminal monitors the PDCCH in each subframe, and receives the PDSCH.

Also, the small cell 1 in the on state transmits the CSI-RS in a predetermined cycle (for example, in a shorter cycle than that of the discovery signal, such as 5 ms, 10 ms, etc.). The user terminal measures CSI by using this CSI-RS. Based on this CSI, the PDSCH of the small cell 1 is scheduled.

Meanwhile, the small cell 2 in the off state stops transmitting the CRS and the PDSCH in every subframe, and stops transmitting the CSI-RS in a predetermined cycle. In FIG. 6, at the same time as command information from the macro base station to the user terminal (SCell activation), the small cell 2 is switched from the off state to the on state. By this means, the small cell 2 starts transmitting the CSI-RS in a predetermined cycle.

The user terminal is commanded by the macro base station to activate the small cell, and, at the same time, starts measuring CSI by using the CSI-RS from the small cell 2. Also, if, at the same time as the activation by the user terminal, the small cell transitions from the off state to the on state and starts transmitting downlink signals such as the CSI-RS, the user terminal can start measuring CSI without delay. The user terminal feeds back this CSI to the small base station. In the small cell 2, the PDSCH, scheduled based on the CSI, starts being transmitted.

As shown in FIG. 5, the user terminal, after receiving an activation command from the macro base station, starts measuring CSI. Meanwhile, as shown in FIG. 6, the CSI-RS is not transmitted from the small cell 2 during the off state, and the CSI-RSstarts being transmitted only after the small cell is switched to the on state. In this way, the user terminal takes time to measure CSI with respect to the small cell 2, the activation of which is commanded from the macro base station, and therefore there is a threat that the transmission of the PDSCH, which is scheduled based on this CSI, delays. As a result of this, there is a threat that the user terminal's throughput in the small cell 2 decreases.

So, the present inventors have worked on the method of reducing the delay time which a small cell takes before starting transmitting data to a user terminal, and arrived at the present invention. To be more specific, the present inventors have come with the idea of reducing the above delay time by allowing a user terminal to switch to the activated state without a command from a macro base station, and enabling the user terminal to measure CSI even when the small cell is in the off state.

(Radio Communication Method)

Now, the radio communication method (communication method) according to the present invention will be described below. The radio communication method according to the present invention is used in a radio communication system comprised of a user terminal that can switch the operation state in a small cell within a macro cell, and a radio base station to form that small cell.

To be more specific, with the radio communication method according to the present invention, a user terminal connects with—that is, communicates with—a macro base station (second base station) and a small base station (first base station) at the same time. Then, when the operation state in the small cell (the cell where mobile communication services are provided from that small base station) is the deactivated state, the user terminal measures channel state information (CSI) periodically by using the small cell's channel state information reference signal (CSI-RS), and monitors the small cell's downlink control channel (PDCCH) periodically. When downlink control information (DCI) for the user terminal is detected during the periodic monitoring of the PDCCH, this user terminal's operation state is switched from the deactivated state to the activated state.

Here, the deactivated state refers to the operation state of the user terminal in the small cell (for example, the small cell in the off state), and the state in which the user terminal is activated on an as-needed basis (for example, periodically) without activating the RF circuit much. Meanwhile, the activated state refers to the operation state of the user terminal in the small cell (for example, the small cell in the on state), and the state in which the user terminal keeps activating the RF circuit in the small cell. Note that the user terminal, when in the deactivated state and in the activated state, will be referred to as “deactivated UE” and “activated UE,” respectively. Also, the deactivated state and the activated state may be both states of connection between the small base station (first base station) and the user terminal.

Also, the radio communication method according to the present invention is not only applicable to cases where dual connectivity (inter-base station carrier aggregation (inter-eNB CA)), in which a user terminal connects with both a macro cell and a small cell, is used, but is also applicable to cases where inter-base station carrier aggregation (intra-eNB CA) is used between the macro cell and the small cell. Although the user terminal may report CSI to the macro cell in inter-base station carrier aggregation, the user terminal may report CSI to the small cell as well. Also, in inter-base station carrier aggregation, the macro cell and the small cell are controlled by one base station, so that the base station to control the macro cell may be understood to schedule the small cell.

Also, the radio communication method according to the present invention is not only applicable to cases where an existing carrier to place the PDCCH is used in small cells, but is also applicable to cases where an incompatible carrier (NCT: New Carrier Type), which has no compatibility with existing carriers, is used. When an NCT is used in a small cell, it may be possible to monitor an enhanced downlink control channel (EPDCCH: Enhanced Physical Downlink Control CHannel), instead of the PDCCH. Below, a case of using an existing carrier in small cells will be described as an example.

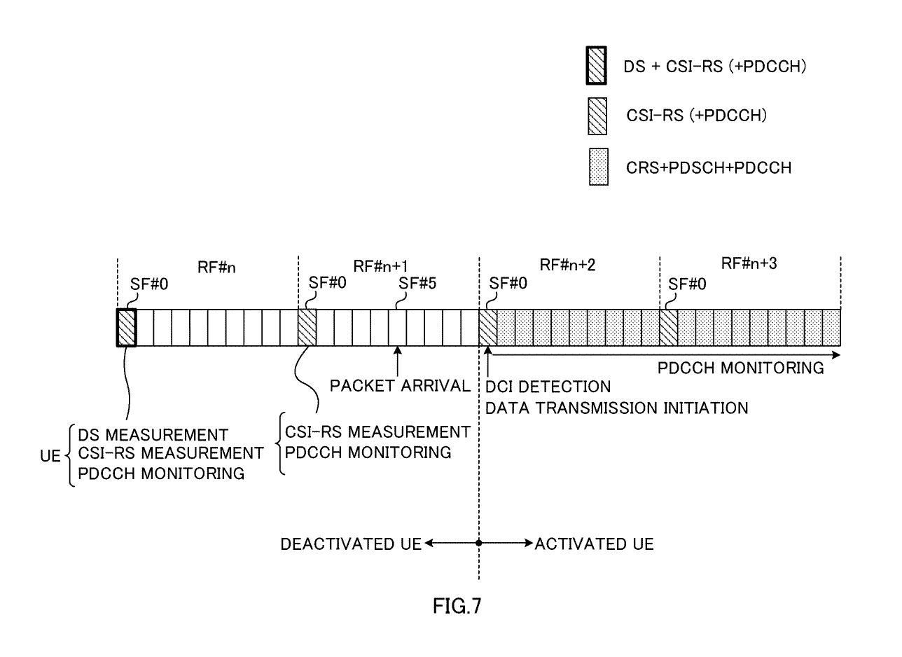

FIG. 5 is a diagram to explain the radio communication method according to the present invention. Note that, with FIG. 7, a case will be described as an example in which a small cell is switched from the off state to the on state (the operation state of a user terminal in the small cell is switched from the deactivated state to the activated state).

As shown in FIG. 7, with the radio communication method according to the present invention, the CSI-RS transmitted in a predetermined cycle, not only when the small cell is in the on state, but also when the small cells is in the off state. Here, the CSI-RS may be transmitted in a shorter cycle (for example, 10 ms in FIG. 7) than that of the discovery signal, or may be transmitted in the same cycle as that of the discovery signal. Also, the CSI-RS and the discovery signal may be transmitted in the same subframe (for example, in subframe (SF) #0 in radio frame (RF) #n, in FIG. 7). Alternatively, the CSI-RS and the discovery signal may be the same signal.

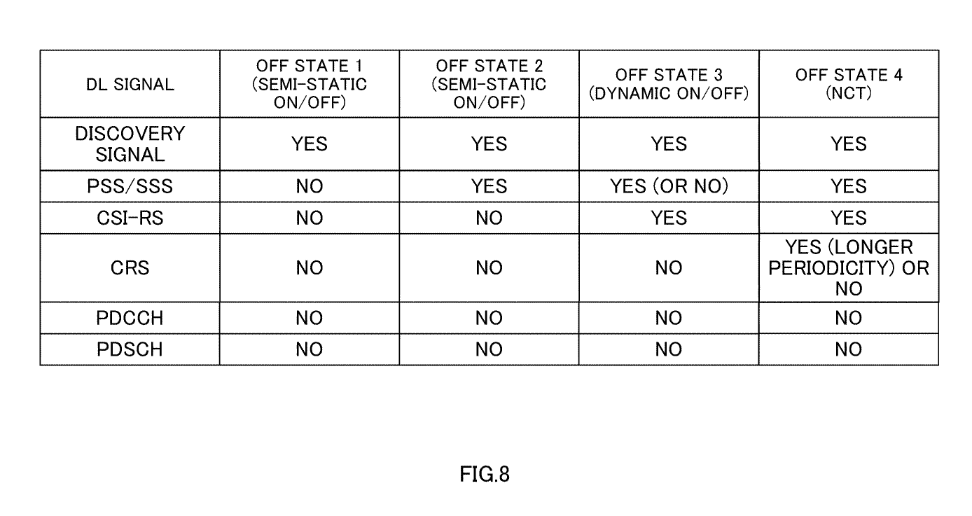

Also, the signals to transmit during the off state are by no means limited to these. For example, the PSS/SSS may be transmitted even during the off state, and the CRS may be transmitted with a low frequency as with an NCT. FIG. 8 shows examples of these off-state downlink transmission signals. As shown in FIG. 8, the off state may include the first to fourth off states, and the downlink transmission signals to transmit may be changed depending on the first to fourth off states.

When the small cell is in the off state (when the operation state of a user terminal in the small cell is in the deactivated state (deactivated UE)), the user terminal measures the small cell's CSI periodically by using the CSI-RS. Note that the user terminal may feed back the measured CSI to the small base station.

Also, when the small cell is in the off state (when the operation state of the user terminal in the small cell is in the deactivated state), the user terminal monitors the downlink control channel (PDCCH) of the small cell periodically. As shown in FIG. 7, the periodic measurement of the CSI-RS and the periodic monitoring of the PDCCH may be carried out in the same subframe (for example, in SF #0 in RF #n and #n+1, in FIG. 7). By this means, the user terminal can reduce the number of times to activate the RF circuit, thereby achieving a battery saving effect.

With the radio communication method according to the present invention, when a small cell is in the off state (when the operation state of a user terminal in the small cell is in the deactivated state) and data for the user terminal is produced, downlink control information (DCI) for this this user terminal is transmitted via the PDCCH. When the DCI for the user terminal is detected by the periodic PDCCH monitoring in the user terminal, the small cell is switched from the off state to the on state (the operation state of the user terminal in the small cell is switched from the deactivated state to the activated state (activated UE)).

For example, as shown in FIG. 7, when data for the user terminal is produced in SF #5 of RF #n+1, the user terminal detects DCI, which includes this data's scheduling information, in SF #0 of RF #n+2, by the periodic PDCCH monitoring. By this means, the small cell is (implicitly) switched from the off state to the on state. That is, with the radio communication method according to the present invention, the operation state of the user terminal in the small cell is switched from the deactivated state to the activated state without command information from the macro base station (SCell activation).

With the radio communication method according to the present invention, when DCI is detected, the small cell switches (implicitly) from the off state to the on state, and switches from the deactivated state to the activated state. Consequently, it is preferable if the small cell can know whether or not the user terminal has detected DCI. To solve this, aperiodic CSI may be always triggered when DCI is transmitted first, so that this reporting of CSI enables the small cell to know whether or not the user terminal has successfully detected DCI.

Also, when DCI is transmitted first, a downlink assignment (DL assignment) and an uplink grant (UL grant) may be both transmitted from the small cell, so that it is possible to prevent DCI detection failures at a higher rate. That is, even when the DL assignment is undetected, it is possible to recognize that the UL grant has been received because the PUSCH has been received, and, on the other hand, even when the UL grant is undetected, it is possible to recognize that the DL assignment has been received because an ACK/NACK in response to the PUCCH has been received.

Note that, although a case has been assumed in the above description where uplink synchronization is established, it is equally possible to assume a case where uplink synchronization is not established, and and allow a user terminal to constantly monitor for a PDCCH for triggering the random access procedures, and, upon receiving this, transition to the activated state.

When a small cell is switched from the off state to the on state (when the operation state of the user terminal in the small cell is switched from the deactivated state to the activated state), the user terminal starts monitoring the PDCCH on a per subframe basis. Also, the user terminal receives data (downlink shared channel (PDSCH)) that is scheduled based on CSI that is measured while the small cell is in the off state (while the operation state of the user terminal in the small cell is in the deactivated state).

In this way, with the radio communication method according to the present invention, CSI is measured even when a small cell is in the off state (when the operation state of a user terminal in the small cell is in the deactivated state), so that, when data for the user terminal is produced, it is possible to schedule this data quickly based on this CSI.

That is, with the radio communication method according to the present invention, when a small cell is switched to the on state, it is possible to carry out PDSCH scheduling by using CSI that is measured during the off state, without waiting for periodic CSI measurement. As a result of this, the user terminal is switched into activation without command information from a macro base station, so that it is possible to reduce the delay time (FIG. 6) that is produced by CSI measurement after a switch to the activated state is made, until data starts being transmitted.

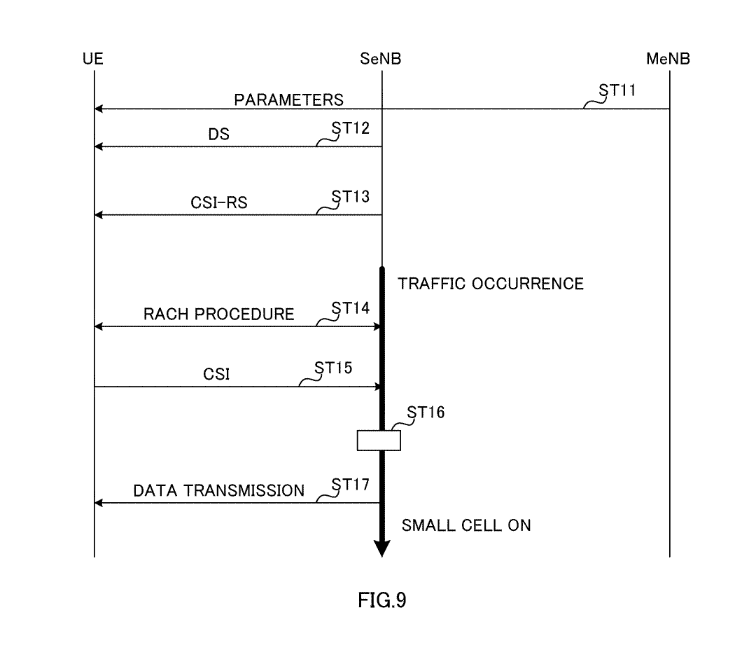

Now, with reference to FIG. 9, the radio communication method according to the present invention will be described in comparison with FIG. 5. FIG. 9 is a sequence diagram to represent the radio communication method according to the present invention. Note that steps ST11, ST12, ST14 and ST16 in FIG. 9 are the same as steps ST101, ST102, ST108 and ST110 in FIG. 5.

As shown in FIG. 9, a small base station, even in the off state, transmits the CSI-RS periodically (step ST13). A user terminal, even in the deactivated state, may transmit CSI, which is measured using the CSI-RS from the small base station, to the small base station (step ST15).

The small base station transmits DCI to represent the scheduling result in step ST16 via the PDCCH, and also transmits the PDSCH (step ST17). When the user terminal in the deactivated state detects the DCI from the small base station by the periodic monitoring of the PDCCH, the user terminal switches its operation state in the small cell from the deactivated state to the activated state. Note that the user terminal may switch the state of connection with the small base station from the deactivated state to the activated state as well.

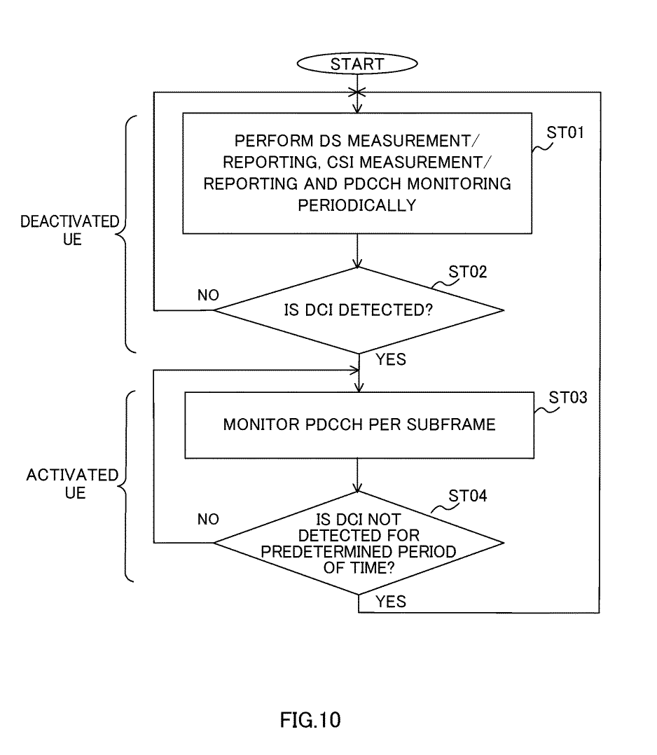

Now, a user terminal's operation states in the radio communication method according to the present invention will be described in detail with reference to FIG. 10. FIG. 10 is a flowchart to show the operation of a user terminal when a small cell is switched from the off state to the on state (when the operation state in the small cell is switched from the deactivated state to the activated state).

As shown in FIG. 10, when the small cell is in the off state (when the operation state of the user terminal in the small cell is in the deactivated state), the user terminal carries out discovery signal measurement and reporting, CSI measurement and reporting, and PDCCH monitoring, periodically (step ST01).

As has been described with reference to FIG. 7, the CSI measurement and the PDCCH monitoring may be carried out in the same subframe. Also, the discovery signal measurement may be carried out in the same cycle as those of the CSI measurement and the PDCCH monitoring, or may be carried out in a different cycle. Also, the discovery signal measurement may be carried out in at least one of the subframes in which the CSI measurement and the PDCCH monitoring are carried out. Alternatively, the CSI-RS and the discovery signal may be the same signal.

Here, transmission timing information pertaining to the PDCCH monitoring and the CSI measurement may be reported from the macro base station to the user terminal via higher layer signaling. Here, the transmission timing-related information may be the indices and the transmission cycle of transmission subframes, or the timing information may be reported in bitmap. Also, in order to lower the frequency of measuring CSI and reduce the battery consumption in the user terminal while the small cell is in the off state, it is possible to change the frequency of the measurement from that when the small cell is in the on state (when the user terminal is in the active state).

When DCI for the user terminal is detected by the periodic PDCCH monitoring (step ST02: Yes), the small cell is switched from the off state to the on state (the operation state of the user terminal in the small cell (or the state of connection between the small base station and the user terminal) is switched from the deactivated state (deactivated UE) to the activated state (activated UE)). In this case, the user terminal monitors the PDCCH on a per subframe basis (step ST03). Note that the user terminal carries out discovery signal measurement and reporting, CSI measurement and reporting and PDCCH monitoring, periodically.

When DCI for the user terminal is not detected for a predetermined period of time by the monitoring of the PDCCH on a per subframe basis (step ST04: Yes), the small cell is switched from the on state to the off state (the operation state of the user terminal in the small cell (or the state of connection between the small base station and the user terminal) is switched from the activated state to the deactivated state) again, and the operation returns to step ST01.

According to the operation shown in FIG. 10, even when the operation state of the user terminal in the small cell is switched from the deactivated state to the activated state, if no DCI is detected for a predetermined period of time, this operation state is switched from the activated state to the deactivated state again. That is, the monitoring of the PDCCH, which is carried out on a per subframe basis, is changed to a longer cycle than a subframe (for example, 5 ms, 10 ms, etc.). Consequently, compared to the case of continuing monitoring the PDCCH on a per subframe basis, it is possible to achieve a battery saving effect.

(Radio Communication System)

Now, the radio communication system according to the present embodiment will be described. Note that the above-described radio communication methods (communication methods) are employed in the radio communication system according to the present embodiment.

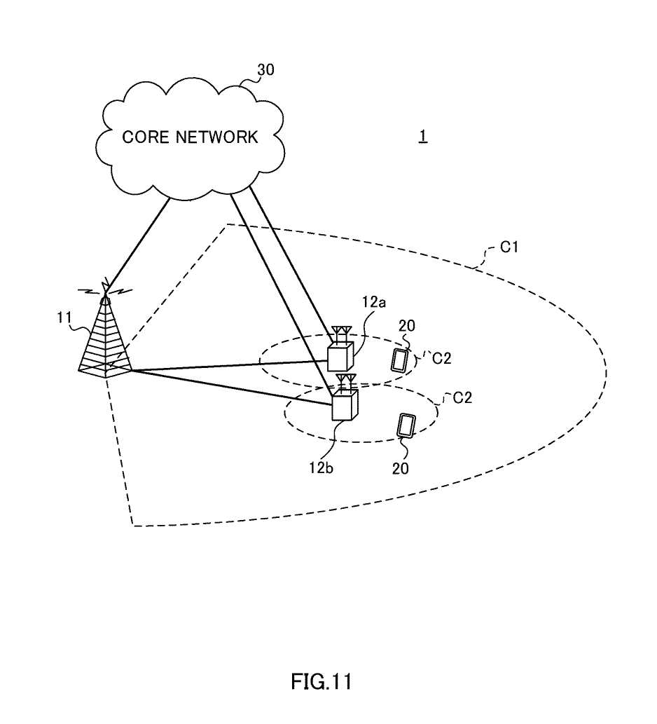

FIG. 11 is a diagram to show an overall structure of a radio communication system 1 according to the present embodiment. Note that the radio communication system 1 shown in FIG. 11 is, for example, an LTE system or a system to incorporate SUPER 3G. This radio communication system may be referred to as “IMT-advanced,” or may be referred to as “4G,” “FRA (Future Radio Access),” etc.

As shown in FIG. 11, the radio communication system 1 has a macro base station 11 that forms a macro cell C1, and small base stations 12a and 12b that form small cells C2 that are placed within the macro cell C1 and that are narrower than the macro cell C1. Also, user terminals 20 are placed in the macro cell C1 and in each small cell C2. Note that the numbers of macro cells C1 (macro base stations 11), small cells C2 (small base stations 12) and user terminals 20 are not limited to those shown in FIG. 11.

Also, user terminals 20 are placed in the macro cell C1 and in each small cell C2. The user terminals 20 are configured to be able to perform radio communication with the macro base station 11 and/or the small base stations 12.

Between the user terminals 20 and the macro base station 11, communication can be carried out using a carrier of a relatively low frequency band (for example, 2 GHz). On the other hand, communication between the user terminals 20 and the small base stations 12 can be carried out using a carrier of a relatively high frequency band (for example, 3.5 GHz and so on). Also, the user terminals 20 may communicate with the small base stations 12 by using a carrier of a licensed band such as, for example, 3.5 GHz, and/or communicate with the small base stations 12 by using a carrier of an unlicensed bands such as, for example, 5 GHz.

The carrier (first carrier) which the macro base station 11 (macro cell C1) uses may be an existing carrier (“legacy carrier type,” “LTE carrier,” etc.). The carrier (second carrier) which the small base stations 12 (small cells C2) use may be an incompatible carrier (NCT: New Carrier Type), which has no compatibility with existing carriers, or may be an existing carrier.

The macro base station 11 and the small base stations 12 may be connected via a relatively high-speed channel (ideal backhaul) such as optical fiber, or may be connected via a relatively low-speed channel (non-ideal backhaul) such as the X2 interface. In the event connection is established with a relatively high-speed channel, the macro base station 11 and the small base stations 12 carry out intra-base station carrier aggregation (intra-eNB CA) (also referred to simply as “carrier aggregation”). In the event connection is established using a relatively low-speed channel, the macro base station 11 and the small base stations 12 carry out inter-base station carrier aggregation (inter-eNB CA) (also referred to as “dual connectivity”).

Similarly, the small base stations 12a and 12b may be connected with a relatively high-speed channel (ideal backhaul) such as optical fiber, or may be connected via a relatively low-speed channel (non-ideal backhaul) such as the X2 interface.

The macro base station 11 and the small base stations 12 are each connected with a core network 30. In the core network 30, core network devices such as an MME (Mobility Management Entity), an S-GW (Serving-GateWay), a P-GW (Packet-GateWay) and so on are provided.

Also, the macro base station 11 is a radio base station (second base station) having a relatively wide coverage, and may be referred to as an “eNodeB,” a “macro base station,” an “aggregation node,” a “transmission point,” a “transmitting/receiving point” and so on. The small base stations 12 are radio base stations (first base station) that have local coverages, and may be referred to as “small base stations,” “pico base stations,” “femto base stations,” “HeNBs (Home eNodeBs),” “RRHs (Remote Radio Heads),” “micro base stations,” “transmission points,” “transmitting/receiving points” and so on.

Also, if no distinction is drawn between the macro base station 11 and the small base stations 12, these will be collectively referred to as the “radio base station 10.” The user terminals 20 are terminals to support various communication schemes such as LTE, LTE-A, FRA and so on, and may include both mobile communication terminals and stationary communication terminals.

Also, in the radio communication system 1, a downlink shared channel (PDSCH: Physical Downlink Shared CHannel), which is used by each user terminal 20 on a shared basis, a downlink control channel (PDCCH: Physical Downlink Control CHannel), an enhanced downlink control channel (EPDCCH: Enhanced Physical Downlink Control CHannel), a broadcast channel (PBCH) and so on are used as downlink physical channels. User data and higher layer control information are communicated by the PDSCH. Downlink control information (DCI) is communicated by the PDCCH and the EPDCCH.

Also, in the radio communication system 1, an uplink shared channel (PUSCH: Physical Uplink Shared CHannel), which is used by each user terminal 20 on a shared basis, and an uplink control channel (PUCCH: Physical Uplink Control CHannel) are used as uplink physical channels. User data and higher layer control information are communicated by the PUSCH. Also, downlink channel state information (CSI), delivery acknowledgment information (ACK/NACK) and so on are communicated by the PUCCH or the PUSCH.

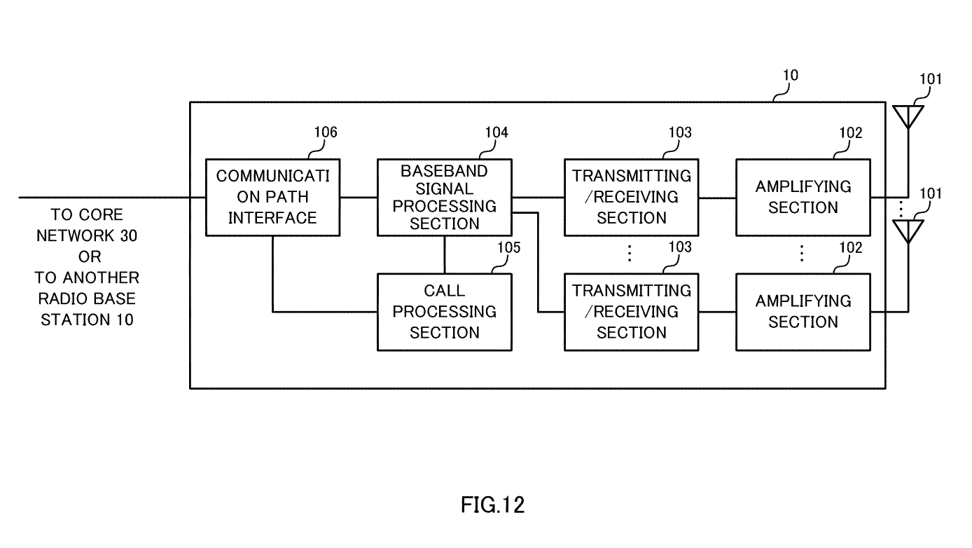

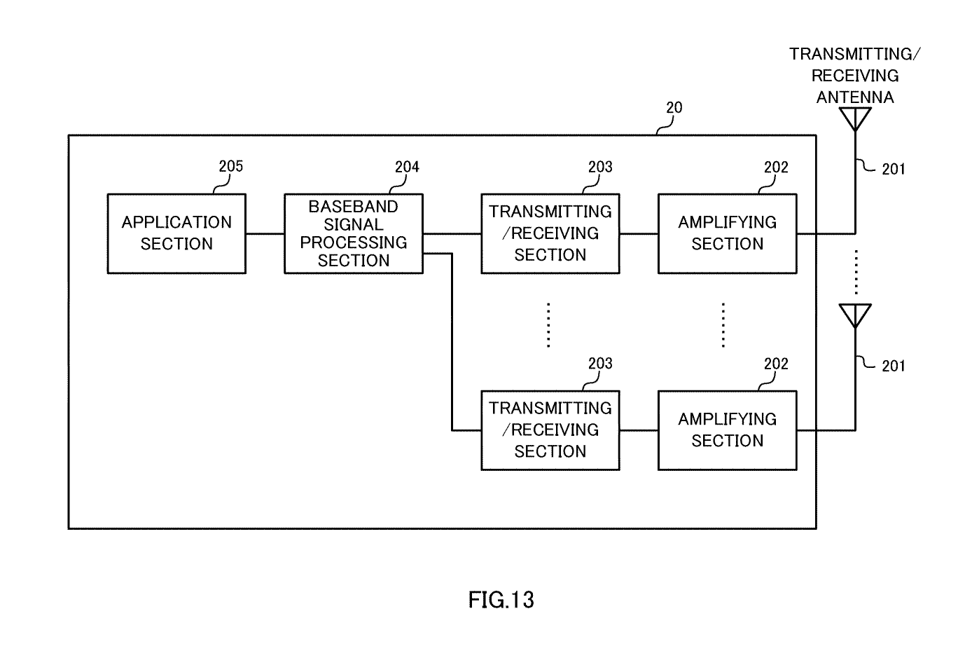

Now, overall structures of a radio base station 10 (which may be either a macro base station 11 (second base station) or a small base station 12 (first base station)) and a user terminal 20 will be described with reference to FIGS. 12 and 13. FIG. 12 is a diagram to show an overall structure of a radio base station 10. As shown in FIG. 12, the radio base station 10 has a plurality of transmitting/receiving antennas 101 for MIMO communication, amplifying sections 102, transmitting/receiving sections 103 (transmitting section and receiving section), a baseband signal processing section 104, a call processing section 105 and a communication path interface 106.

User data to be transmitted from the radio base station 10 to the user terminal 20 on the downlink is input from the S-GW provided in the core network 30, into the baseband signal processing section 104, via the communication path interface 106.

In the baseband signal processing section 104, a PDCP layer process, division and coupling of user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is forwarded to each transmitting/receiving section 103. Furthermore, downlink control signals (including reference signals, synchronization signals, broadcast signals and so on) are also subjected to transmission processes such as channel coding and an inverse fast Fourier transform, and are forwarded to each transmitting/receiving section 103.

Each transmitting/receiving section 103 converts the downlink signals, pre-coded and output from the baseband signal processing section 104 on a per antenna basis, into a radio frequency. The amplifying sections 102 amplify the radio frequency signals having been subjected to frequency conversion, and transmit the signals through the transmitting/receiving antennas 101.

On the other hand, as for uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, the user data that is included in the input uplink signals is subjected to an FFT process, an IDFT process, error correction decoding, a MAC retransmission control receiving process and RLC layer and PDCP layer receiving processes, and the result is forwarded to the core network 30 via the communication path interface 106. The call processing section 105 performs call processing such as setting up and releasing communication channels, manages the state of the radio base stations 10 and manages the radio resources.

FIG. 13 is a diagram to show an overall structure of a user terminal 20 according to the present embodiment. The user terminal 20 has a plurality of transmitting/receiving antennas 201 for MIMO communication, amplifying sections 202, transmitting/receiving sections (transmitting section and receiving section) 203, a baseband signal processing section 204 and an application section 205. Note that the user terminal 20 may switch the receiving frequency using one receiving circuit (RF circuit), or may have a plurality of receiving circuits. Also, the receiving circuit (RF circuit) is capable of switching between the on state and the off state.

As for downlink signals, radio frequency signals that are received in a plurality of transmitting/receiving antennas 201 are each amplified in the amplifying sections 202, subjected to frequency conversion in the transmitting/receiving sections 203, and input in the baseband signal processing section 204. In the baseband signal processing section 204, an FFT process, error correction decoding, a retransmission control receiving process and so on are performed. The user data that is included in the downlink signals is forwarded to the application section 205. The application section 205 performs processes related to higher layers above the physical layer and the MAC layer. Furthermore, in the downlink data, broadcast information is also forwarded to the application section 205.

Meanwhile, uplink user data is input from the application section 205 to the baseband signal processing section 204. In the baseband signal processing section 204, a retransmission control (H-ARQ (Hybrid ARQ)) transmission process, channel coding, precoding, a DFT process, an IFFT process and so on are performed, and the result is forwarded to each transmitting/receiving section 203. The baseband signal that is output from the baseband signal processing section 204 is converted into a radio frequency in the transmitting/receiving sections 203. After that, the amplifying sections 202 amplify the radio frequency signal having been subjected to frequency conversion, and transmit the resulting signal from the transmitting/receiving antennas 201.

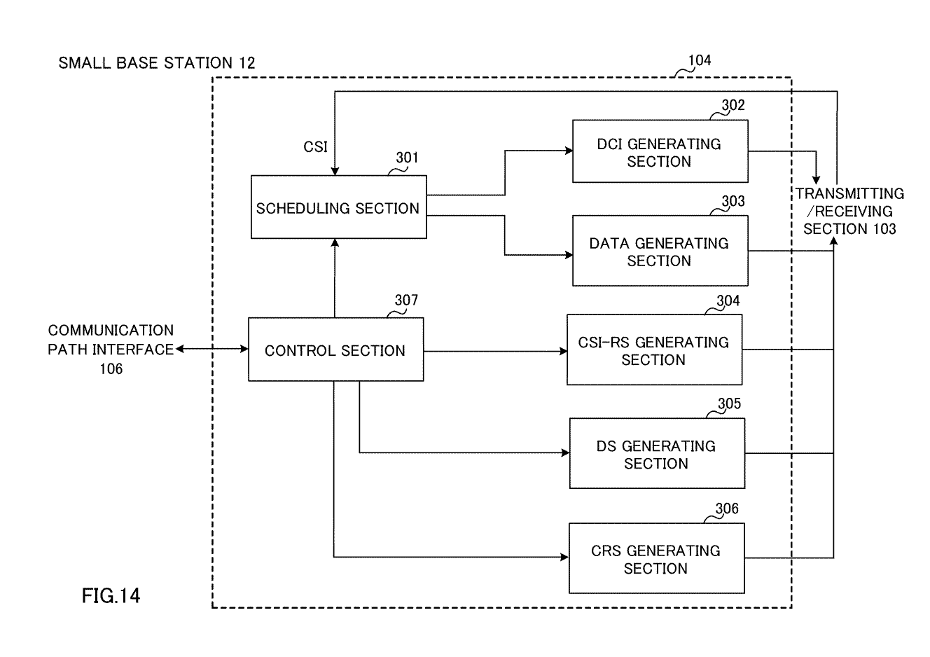

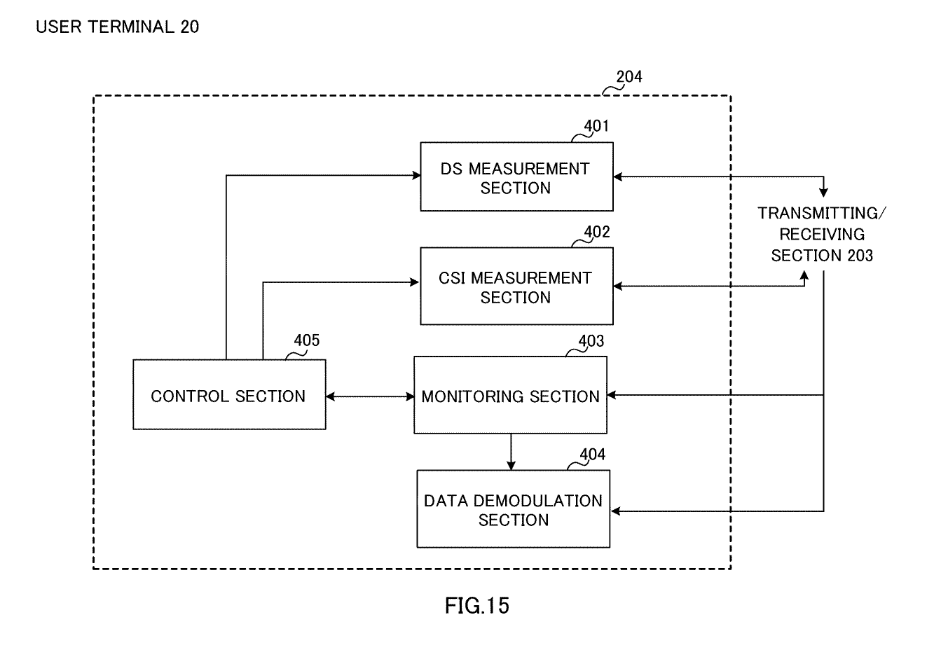

Next, detailed structures of a small base station 12 and a user terminal 20 will be described with reference to FIGS. 14 and 15. The detailed structure of a small base station 12 shown in FIG. 14 is primarily comprised of a baseband signal processing section 104. Also, the detailed structure of a user terminal 20 shown in FIG. 15 is comprised primarily of a baseband signal processing section 204.

FIG. 14 is a diagram to show a detailed structure of a small base station 12 (first base station) according to the present embodiment. As shown in FIG. 14, the small base station 12 has a scheduling section 301, a DCI generating section 302, a data generating section 303, a CSI-RS generating section (generating section) 304, a DS generating section 305, a CRS generating section 306 and a control section 307.

The scheduling section 301 schedules the PDSCH for the user terminal 20 (including allocating resources, determining the MCS (Modulation and Coding Scheme), determining the precoding matrix and so on) based on CSI (including at least one of CQI, PMI and RI) that is received in the transmitting/receiving sections 103. The scheduling section 301 outputs the scheduling result to the DCI generating section 302 and the data generating section 303.

Note that, since the scheduling is carried out in the macro base station 11 while inter-base station carrier aggregation is used between the macro base station 11 and the small base station 12, the scheduling section 301 may be removed then. In this case, the result of scheduling in the macro base station 11 is input in the control section 307 via the communication path interface 106.

The DCI generating section 302 generates downlink control information (DCI). To be more specific, the DCI generating section 302 generates DCI representing the result of scheduling in the scheduling section 301. The DCI is output to the transmitting/receiving sections 103 and transmitted to the user terminal 20 via the PDCCH or the EPDCCH.

Also, the DCI generating section 302, when generating the first DCI for the user terminal 20 (DCI for detecting a switch to the activated state (on state)), may generate DCI that includes aperiodic CSI trigger information.

Also, the DCI generating section 302, when generating the first DCI for the user terminal 20 (DCI for detecting a switch to the activated state (on state)), may generate DCI that includes both a downlink assignment (DL assignment) and an uplink grant (UL grant).

The data generating section 303 generates data based on the scheduling result in the scheduling section 301. To be more specific, the data generating section 303 performs coding, modulation and precoding of the data for the user terminal 20. This data is output to the transmitting/receiving sections 103, and transmitted to the user terminal 20 via the PDSCH. Note that, in addition to traffic data (user data), higher layer (for example, RRC signaling, MAC signaling and so on) control information may be included in this data.

The CSI-RS generating section 304 generates the channel state information reference signal (CSI-RS). To be more specific, in accordance with control by the control section 307, the CSI-RS generating section 304 generates the CSI-RS, which is transmitted periodically (for example, in a 10-ms cycle, in a 5-ms cycle and so on), regardless of whether or not there is data for the user terminal 20. That is, the CSI-RS generating section 304 generates the CSI-RS, which is transmitted periodically, not only when the small cell C2 is in the on state, but also when the small cell C2 is in the off state.

The CSI-RS, generated in the CSI-RS generating section 304, is output to the transmitting/receiving sections 103, and transmitted in the small cell C2. Note that CSI-RSs are generated so as to be orthogonal between small cells C2. Also, CSI-RSs are placed in a predetermined cycle (for example, 5 ms, 10 ms, etc.), and placed in a relatively low density. Consequently, even when the CSI-RS is transmitted from a small cell C2 while in the off state, the impact of interference against neighboring small cells C2 is limited.

The DS generating section 305 generates the discovery signal (DS). To be more specific, in accordance with control by the control section 307, the DS generating section 305 generates the discovery signal, which is transmitted periodically (for example, in a 100-ms cycle, in a 5-ms cycle and so on), regardless of whether or not there is data for the user terminal 20. That is, the DS generating section 305 generates the discovery signal, which is transmitted periodically, not only when the small cell C2 is in the on state, but also when the small cell C2 is in the off state.

The discovery signal generated in the DS generating section 305 is output to the transmitting/receiving sections 103, and transmitted in the small cell C2. Note that the discovery signals may be placed in a relatively high density and transmitted in bursts. Also, the discovery signals may be transmitted synchronously between small cells C2. Also, the discovery signal may be transmitted in the same cycle as that of the CSI-RS or in a longer cycle than that of the CSI-RS, or may be transmitted in at least one of the subframes in which the CSI-RS is transmitted.

The CRS generating section 306 generates the cell-specific reference signal (CRS). To be more specific, in accordance with control by the control section 307, the CRS generating section 306 generates the CRS, which is multiplexed over the data generated in the data generating section 303.

The CRS generated in the CRS generating section 306 is output to the transmitting/receiving sections 103, and multiplexed and transmitted with data generated in the data generating section 303. That is, the CRS generating section 306 carries out transmission when the small cell C2 is in the on state, and carries out no transmission when the small cell C2 is in the off state. As noted earlier, CRSs may not be necessarily orthogonal between small cells C2. Also, CRSs are placed in each subframe, and placed in a relatively high density. Consequently, by stopping the transmission of CRSs while the small cell C2 is in the off state, it is possible to reduce the interference against neighboring small cells C2.

The control section 307 controls the scheduling section 301, the CSI-RS generating section 304, the DS generating section 305 and the CRS generating section 306. Note that, when inter-base station carrier aggregation is executed between the macro base station 11 and small base station 12, the control section 307 may control the DCI generating section 302 and the data generating section 303 directly, based on scheduling results in the macro base station 11.

To be more specific, the control section 307 has the scheduling section 301, the CSI-RS generating section 304, the DS generating section 305 and the CRS generating section 306 based on whether or not there is data for the user terminal 20 (the on/off state of the small cell C2).

Also, the control section 307 may control the switching of the on/off state of the small cell C2. To be more specific, when data for the user terminal 20 is produced, the control section 307, in order to activate the user terminal 20, carries out scheduling based on CSI reported from the user terminal 20, and commands the DCI generating section 302, the data generating section 303 and the CRS generating section 306 to transmit downlink signals (so the small cell C2 switches to the on state at this timing). Note that the on/off state switching of the small cell C2 may be carried out explicitly, based on command information (SCell activation) from the macro base station 11.

FIG. 15 is a diagram to show a detailed structure of a user terminal 20 according to the present embodiment. As shown in FIG. 15, a user terminal 20 has a DS measurement section (measurement section) 401, a CSI measurement section (measurement section) 402, a monitoring section 403, a data demodulation section 404 and a control section 405.

In accordance with control by the control section 405, the DS measurement section 401 measures the received power and/or the received quality (hereinafter referred to as “received power”/“received quality”) of the discovery signal of the small cell C2 received in the transmitting/receiving sections 203. As mentioned earlier, the received power may be, for example, the RSRP, and the received quality may be, for example, the RSRQ, the SINR and so on. To be more specific, the DS measurement section 401 measures the received power/received quality of the discovery signal, periodically, regardless of the on/off state of the small cell C2 (the operation state of the user terminal 20 in the small cell C2 (or the state of connection between the user terminal 20 and the small base station 12).

A measurement report (MR) to represent the measurement result in the DS measurement section 401 is output to the transmitting/receiving sections 203, and transmitted to the macro base station 11. This measurement report may be transmitted through higher layer signaling such as RRC signaling. Based on this measurement report, a small cell (Scell) to be involved in inter-base station carrier aggregation or inter-base station carrier aggregation (dual connectivity) with respect to the user terminal 20 is configured.

In accordance with control by the control section 405, the CSI measurement section 402 measures (generates) CSI by using the CSI-RS of the small cell C2, received in the transmitting/receiving sections 203. As noted earlier, the CSI includes at least one of CQI, RI and PMI.

To be more specific, when the small cell C2 is in the off state (when the operation state of the user terminal 20 in the small cell C2 (or the state of connection between the user terminal 20 and the small base station 12) is in the deactivated state), the CSI measurement section 402 measures CSI periodically. Also, the CSI measurement section 402 may measure CSI periodically when the small cell C2 is in the on state (when the operation state of the user terminal 20 in the small cell C2 (or the state of connection between the user terminal 20 and the small base station 12) is in the activated state).

The CSI that is measured in the CSI measurement section 402 is output to the transmitting/receiving sections 203, and transmitted in the PUCCH or the PUSCH. When inter-base station carrier aggregation is used between the macro base station 11 and the small base station 12, the CSI may be transmitted (reported) to the macro base station 11. Also, when inter-base station carrier aggregation (dual connectivity) is used between the macro base station 11 and the small base station 12, this CSI may be transmitted (reported) to the small base station 12.

The monitoring section 403 monitors the downlink control channel (PDCCH) of the small cell C2 in accordance with control by the control section 405. Note that the monitoring section 403 may monitor the enhanced downlink control channel (EPDCCH) of the small cell C2.

Here, monitoring the PDCCH (or the EPDCCH) means blind-decoding the search space. By this monitoring of the PDCCH, DCI for the user terminal 20 is detected. To be more specific, the monitoring section 403 monitors the PDCCH (or the EPDCCH), periodically, when the small cell C2 is in the off state (when the operation state of the user terminal 20 in the small cell C2 (or the state of connection between the user terminal 20 and the small base station 12) is in the deactivated state).

Also, when the small cell C2 is switched from the off state to the on state (when the operation state of the user terminal 20 in the small cell C2 (or the state of connection between the user terminal 20 and the small base station 12) is switched from the deactivated state to the activated state), the monitoring section 403 monitors the PDCCH (or the EPDCCH) on a per subframe basis.

Here, when the small cell C2 is in the off state (when the operation state of the user terminal 20 in the small cell C2 (or the state of connection between the user terminal 20 and the small base station 12) is in the deactivated state), the CSI measurement in the CSI measurement section 402 and the PDCCH monitoring in the monitoring section 403 may be carried out in the same subframe (SF #0 of RF #n and #n+1 in FIG. 7).

Also, when the small cell C2 is in the off state (when the operation state of the user terminal 20 in the small cell C2 (or the state of connection between the user terminal 20 and the small base station 12) is in the deactivated state), the DS received power/received quality measurement in the DS measurement section 401 may be carried out in the same cycle as, or in a different cycle from, those of the CSI measurement in the CSI measurement section 402 and the PDCCH (or EPDCCH) monitoring in the monitoring section 403. Also, the DS received power/received quality measurement in the DS measurement section 401 may be carried out in at least one of the subframes in which the CSI measurement by the CSI measurement section 402 and the PDCCH (or EPDCCH) monitoring by the monitoring section 403 are performed (SF #0 of RF #n in FIG. 7).

Also, information about the PDCCH and CSI transmission timings for use in the PDCCH monitoring by the monitoring section 403 and in the CSI measurement by the CSI measurement section 402 may be reported from the macro base station 11 to the user terminal 20 via higher layer signaling. Here, the transmission timing information may be the indices and/or the transmission cycles of PDCCH and/or CSI-transmitting subframes, or may be bitmap.

The data demodulation section 404 performs the demodulation, decoding and so on of the PDSCH received in the transmitting/receiving sections 203, based on DCI that is detected by the monitoring of the PDCCH (or EPDCCH) by the monitoring section 403. Note that, when the small cell C2 is switched from the off state to the on state (when the operation state of the user terminal 20 in the small cell C2 is switched from the deactivated state to the activated state), the transmitting/receiving section 203 may receive the PDSCH transmitted based on CSI that is measured during the deactivated state, and the data demodulation section 404 may perform the demodulation, decoding and so on of this PDSCH.

The control section 405 controls the DS measurement section 401, the CSI measurement section 402 and the monitoring section 403. To be more specific, the control section 405, when DCI for the user terminal 20 is detected by the periodic monitoring of the PDCCH (or the EPDCCH) in the monitoring section 403, switches the small cell C2 from the off state to the on state (switches the operation state of the user terminal 20 in the small cell C2 from the deactivated state to the activated state).

Also, when DCI for the user terminal 20 is not detected for a predetermined period of time by the monitoring of the PDCCH (or the EPDCCH) on a per subframe basis by the monitoring section 403, the control section 405 may switch the small cell C2 from the on state to the off state (may switch the operation state of the user terminal 20 in the small cell C2 from the activated state to the deactivated state).

Note that the deactivated state and the activated state may both refer to states of connection between the small base station 12 (the first base station) and the user terminal 20. In this case, when DCI for the user terminal 20 is detected by the periodic PDCCH (or EPDCCH) monitoring by the monitoring section 403, the control section 405 may switch the state of connection between the small base station 12 and the user terminal 20 from the deactivated state to the activated state. Also, when DCI for the user terminal 20 is not detected for a predetermined period of time by the monitoring of the PDCCH (or EPDCCH) on a per subframe basis by the monitoring section 403, the control section 405 may switch the activated state to the deactivated state.

As described above, with the radio communication system 1 according to the present embodiment, CSI is measured even when a small cell C2 is in the off state (when the operation state of a user terminal 20 in the small cell C2 (or the state of connection between the user terminal 20 and the small base station 12) is in the deactivated state). Consequently, when the small cell C2 is switched to the on state (when the operation state of the user terminal 20 in the small cell C2 (or the state of connection between the user terminal 20 and the small base station 12) is switched to the activated state), PDSCH scheduling can be carried out without waiting for periodic CSI measurement. As a result of this, it is possible to reduce the delay time (FIG. 6) that is produced due to CSI measurement before data starts being transmitted.

Also, with the radio communication system 1 according to the present embodiment, even when the state of operation of a user terminal 20 is switched from the deactivated state to the activated state in a small cell C2, if DCI is not detected for a predetermined period of time, this operation state is switched back from the activated state to the deactivated state again. That is, the PDCCH monitoring, which is carried out on a per subframe basis, is changed to a longer cycle than a subframe (for example, 5 ms, 10 ms, etc.). Consequently, compared to the case of continuing monitoring the PDCCH on a per subframe basis, it is possible to achieve an effect of battery saving in the user terminal 20.

Now, although the present invention has been described in detail with reference to the above embodiments, it should be obvious to a person skilled in the art that the present invention is by no means limited to the embodiments described herein. The present invention can be implemented with various corrections and in various modifications, without departing from the spirit and scope of the present invention defined by the recitations of claims. Also, each embodiment may be combined as appropriate and implemented. Consequently, the description herein is only provided for the purpose of illustrating examples, and should by no means be construed to limit the present invention in any way.

The disclosure of Japanese Patent Application No. 2014-058836, filed on Mar. 20, 2014, including the specification, drawings and abstract is incorporated herein by reference in its entirety.

1. A user terminal that communicates with a first base station and a second base station at the same time, the user terminal comprising:
a measurement section that, when a state of connection between the first base station and the user terminal is a deactivated state, periodically measures channel state information, by using a channel state information reference signal that is transmitted from the first base station; and
a monitoring section that, when the state of connection is the deactivated state, periodically monitors a downlink control channel that is transmitted from the first base station,
wherein, when downlink control information for the user terminal is detected by the periodic monitoring of the downlink control channel, the state of connection is switched from the deactivated state to an activated state.

2. The user terminal according to claim 1, further comprising a transmission section that, when the state of connection is the deactivated state, transmits the channel state information measured in the measurement section, to the first base station.

3. The user terminal according to claim 1, wherein, when the state of connection is switched from the deactivated state to the activated state, the monitoring section monitors the downlink control channel on a per subframe basis.

4. The user terminal according to claim 3, wherein, when the downlink control information is not detected for a predetermined period of time by the monitoring of the downlink control channel on a per subframe basis, the state of connection is switched from the activated state to the deactivated state.

5. The user terminal according to claim 1, wherein, when the state of connection is the deactivated state, the measurement of the channel state information and the monitoring of the downlink control channel are carried out in a same subframe.

6. The user terminal according to claim 5, wherein:
when the state of connection is the deactivated state, the measurement section periodically measures received power and/or received quality of a small cell detection/measurement signal; and
the received power and/or received quality is measured in at least one of subframes where the measurement of the channel state information and the monitoring of the downlink control channel are performed.

7. The user terminal according to claim 1, wherein:
the first base station is a small base station that forms a small cell within a macro cell;
the second base station is a macro base station that forms the macro cell; and
the user terminal communicates with the small base station and the macro base station at the same time by using inter-base station carrier aggregation or inter-base station carrier aggregation.

8. A first base station that communicates with a user terminal, the user terminal communicating with the first base station and a second base station at the same time, the first base station comprising:
a generating section that generates a channel state information reference signal; and
a transmission section that, when a state of connection between the first base station and the user terminal is a deactivated state, transmits the channel state information reference signal periodically,
wherein, when data for the user terminal is produced, the transmission section transmits downlink control information for the user terminal via a downlink control channel.

9. (canceled)

10. A communication method in a user terminal that communicates with a first base station and a second base station at the same time, the communication method comprising the steps of:
when a state of connection between the first base station and the user terminal is a deactivated state, periodically measuring channel state information, by using a channel state information reference signal that is transmitted from the first base station; and
when the state of connection is the deactivated state, periodically monitoring a downlink control channel that is transmitted from the first base station,
wherein, when downlink control information for the user terminal is detected by the periodic monitoring of the downlink control channel, the state of connection is switched from the deactivated state to an activated state.

11. The user terminal according to claim 2, wherein, when the state of connection is switched from the deactivated state to the activated state, the monitoring section monitors the downlink control channel on a per subframe basis.

12. The user terminal according to claim 2, wherein, when the state of connection is the deactivated state, the measurement of the channel state information and the monitoring of the downlink control channel are carried out in a same subframe.

13. The user terminal according to claim 3, wherein, when the state of connection is the deactivated state, the measurement of the channel state information and the monitoring of the downlink control channel are carried out in a same subframe.

14. The user terminal according to claim 4, wherein, when the state of connection is the deactivated state, the measurement of the channel state information and the monitoring of the downlink control channel are carried out in a same subframe.

15. The user terminal according to claim 2, wherein:
the first base station is a small base station that forms a small cell within a macro cell;
the second base station is a macro base station that forms the macro cell; and
the user terminal communicates with the small base station and the macro base station at the same time by using inter-base station carrier aggregation or inter-base station carrier aggregation.

16. The user terminal according to claim 3, wherein:
the first base station is a small base station that forms a small cell within a macro cell;
the second base station is a macro base station that forms the macro cell; and
the user terminal communicates with the small base station and the macro base station at the same time by using inter-base station carrier aggregation or inter-base station carrier aggregation.

17. The user terminal according to claim 4, wherein:
the first base station is a small base station that forms a small cell within a macro cell;
the second base station is a macro base station that forms the macro cell; and
the user terminal communicates with the small base station and the macro base station at the same time by using inter-base station carrier aggregation or inter-base station carrier aggregation.

18. The user terminal according to claim 5, wherein:
the first base station is a small base station that forms a small cell within a macro cell;
the second base station is a macro base station that forms the macro cell; and
the user terminal communicates with the small base station and the macro base station at the same time by using inter-base station carrier aggregation or inter-base station carrier aggregation.

19. The user terminal according to claim 6, wherein:
the first base station is a small base station that forms a small cell within a macro cell;
the second base station is a macro base station that forms the macro cell; and
the user terminal communicates with the small base station and the macro base station at the same time by using inter-base station carrier aggregation or inter-base station carrier aggregation.
